(19) United States
(12) Patent Application Publication
(10) Pub. No.: US 2010/0240319 A1
(43) Pub. Date: Sep. 23, 2010

(54) RADIO SYSTEM, TRANSMITTER, AND RECEIVER

(76) Inventor: Ryoko MATSUO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/725,118

(22) Filed: Mar. 16, 2010

(30) Foreign Application Priority Data
Mar. 17, 2009 (JP) P2009-065202

(51) Int. Cl. H04B 1/00; H01Q 11/12; H04B 1/06

(52) U.S. Cl. 455/68; 455/127.5; 455/352

(57) ABSTRACT

A wireless communication system includes a transmitter and a receiver. The transmitter transmits signals to a receiver at a transmission interval. One of the signals is an association request signal. The transmitter includes a transmitting unit. The transmitting unit transmits the signals except the association request signal at the transmission interval of a first time interval, and transmits the association request signal at the transmission interval of a second time interval. The first time interval is different from the second time interval. The receiver includes an antenna, a receiving unit and a wake-up determining unit. The antenna receives the signals. The receiving unit performs receiving processing for the signals. The wake-up determining unit determines whether or not the signal is the association request signal based on the transmission interval. The wake-up determining unit activates the receiving unit if the signal is the association request signal.

### CROSS REFERENCE TO RELATED APPLICATIONS

This application is based upon and claims the benefit of priority from the Japanese Patent Application No. 2009-065202, filed on Mar. 17, 2009, the entire contents of which are incorporated herein by reference.

### FIELD

The disclosure relates generally to a radio system, a radio transmitter and a radio receiver.

### BACKGROUND

One of techniques to reduce a power consumption in wireless communication systems is disclosed in JP-A 2006-148906 (KOKAI). In this reference, a receiver is in a sleep mode to save a power and a transmitter transmits a wake-up indication when the transmitter wants to transmit data to the receiver. The receiver wakes up every a certain time in order to receive the wake-up indication. If the receiver receives the wake-up indication, the receiver keeps being awake in order to receive data signals form the transmitter. On the other hand, if the receiver does not receive the wake-up indication, the receiver returns back to the sleep mode.

However, the receiver may waste the power because the receiver wakes up every the certain time regardless of whether or not the transmitter transmits the wake-up indication.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a block diagram showing a wireless communication system according to the first embodiment;

FIG. 2 is a block diagram showing a radio apparatus;

FIG. 3A is a block diagram showing a rectifier;

FIG. 3B is a wave form of a signal inputted into rectifier;

FIG. 3C is a wave form of a signal outputted from the rectifier;

FIG. 4A is a signal sequence transmitted in the air following time;

FIG. 4B is a signal sequence inputted into the power controller;

FIG. 5 is a sequence chart for explaining operation of the wireless communication system;

FIG. 6 is a block diagram showing a radio apparatus according to the second embodiment;

FIG. 7A is a figure showing a time interval for a channel A;

FIG. 7B is a figure showing a time interval for a channel B;

FIG. 7C is a figure showing a time interval for a channel C;

FIG. 8 is a sequence chart for explaining operation of the wireless communication system;

FIG. 9 is a block diagram showing a radio apparatus according to the third embodiment;

FIG. 10A is a signal sequence transmitted in the air following time;

FIG. 10B is a figure showing level of transmission power following time;

FIG. 10C is a figure showing reception sensitivity following time; and

FIG. 11 is a sequence chart for explaining operation of the wireless communication system.

### DETAILED DESCRIPTION

According to one aspect of the invention, a wireless communication system including a transmitter to transmit signals and a receiver to receive the signals at a transmission interval, one of the signals being an association request signal, comprising:

the transmitter including:
a transmitting unit configured to transmit the signals except the association request signal at the transmission interval of a first time interval, and to transmit the association request signal at the transmission interval of a second time interval, the second time interval being different from the first time interval,

and

the receiver including:
an antenna to receive the signals;
a receiving unit configured to perform receiving processing for the signals; and
a wake-up determining unit configured to determine whether or not the signal is the association request signal based on the transmission interval, the wake-up determining unit activating the receiving unit if the signal is the association request signal.

According to another aspect of the invention, a transmitter for transmitting signals at a transmission interval, one of the signals being an association request signal, comprising:

a transmitting unit configured to transmit the signals except the association request signal at the transmission interval of a first time interval, and to transmit the association request signal at the transmission interval of a second time interval, the second time interval being different from the first time interval.

According to another aspect of the invention, a receiver includes:

an antenna for receiving signals transmitted at a transmission interval;

a receiving unit configured to perform receiving processing for the signals; and

a wake-up determining unit configured to determine whether or not the signal is an association request signal based on the transmission interval, the wake-up determining unit activating the receiving unit if the signal is the association request signal.

The embodiments will be explained with reference to the accompanying drawings.

### Description of the First Embodiment

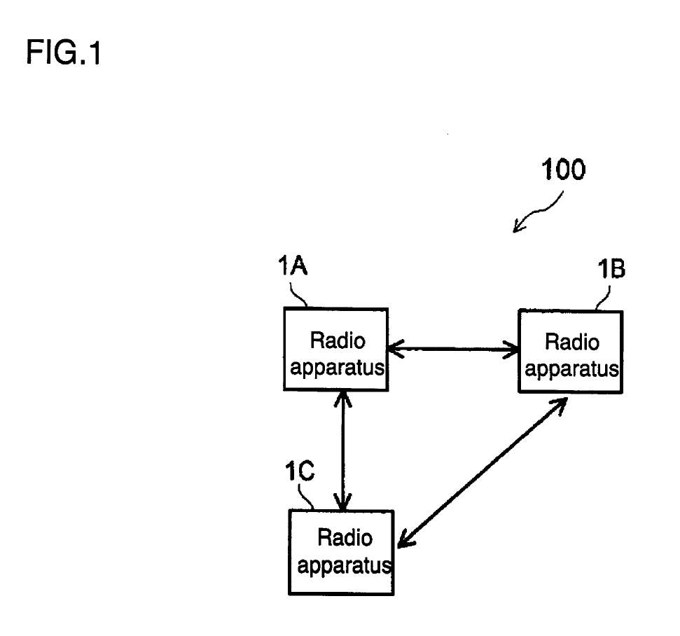

As shown in FIG. 1, a wireless communication system 100 includes radio apparatuses 1A, 1B, 1C. The wireless communication system 100 performs near field communications. Each distance between any two of the radio apparatuses 1A, 1B, 1C is about several ten [cm]. In FIG. 1, number of the radio apparatuses is three, but it is not limited three. Each of the radio apparatuses 1A, 1B, 1C acts as both a transmitter and a receiver.

In the wireless communication system 100, an access point does not exist. Therefore, the radio apparatuses communicate with each other without through the access point. Before starting communication, the radio apparatus sets up connection by exchanging an association request signal and an association response signal. The radio apparatus may transmit the association request signal periodically. Also, the radio apparatus may transmit the association request signal using a random backoff based on a carrier sense (CS). In the random backoff, the radio apparatus waits to transmit until it detect an idle channel (frequency band) and a random time passes after detection of the idle channel.

Contention Window is used to determine the random time. The Contention Window is a time length including several time slots. A time slot is a time unit in the wireless communication system 100. The Contention Window has a maximum number CWmax and a minimum number CWmin. The number of the time slots included in the Contention Window is randomly chosen between the maximum number CWmax and the minimum number CWmin. In the first embodiment, the Contention Window is set into the radio apparatuses 1A, 1B, 1C. Each radio apparatus 1A, 1B, 1C transmits data signal after the random time due to the Contention Window has passed since it detected the idle channel.

After establishing the connection, the radio apparatus 1A, 1B, 1C transmits data signals according to an time interval T1 (first time interval). The time interval T1 may be a SIFS (short inter frame space). The SIFS is the shortest time interval between frame transmissions in wireless LAN systems using IEEE802.11. The radio apparatus 1A, 1B, 1C transmits an acknowledge signal within the SIFS time since they succeeded in receiving data signal.

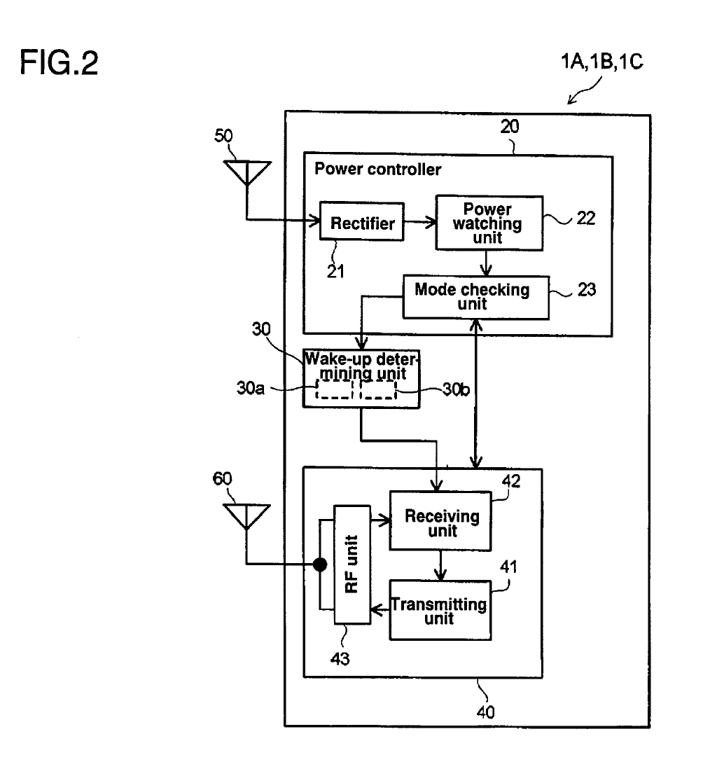

As shown in FIG. 2, each radio apparatus 1A, 1B, 1C includes a power controller 20, a wake-up determining unit 30, a transmitting and receiving unit 40, an antenna 60, and an antenna 60. The power controller 20 further includes a rectifier 21, a power watching unit 22, and a mode checking unit 23. The transmitting and receiving unit 40 further includes a transmitting unit 41, a receiving unit 42, and an RF unit 43.

If the radio apparatus 1A, 1B, 1C always detects reception of a signal and checks destination of the signal (hereinafter, referred to as “waiting mode”), a power consumption of the wireless communication system 100 may increase. Especially, the power consumption becomes more severe in a small radio communication apparatus or in the wireless communication system with low and distributed traffic.

In the first embodiment, the radio apparatuses 1A, 1B, 1C are operating below in order to reduce the power consumption.

1. The transmitting and receiving unit 40 may consume large power. Therefore, the transmitting and receiving unit 40 is normally inactive (hereinafter, referred to as “sleep mode”) in order to save the power.
2. The power controller 20 consumes lower power than the transmitting and receiving unit 40. Therefore, arrival of the signal is detected by the power controller 20.
3. When the power controller 20 detects the signal, the transmitting and receiving unit 40 quits the sleep mode and transmits to the waiting mode.

The power consumption of the transmitting and receiving unit 40 may be larger than several [mW] because it transmits and receives signals. On the other hand, the power consumption of the power controller 20 may be one-several [mW] of the power consumption of the transmitting and receiving unit 40 because it only detects the arrival of the signals. Therefore, the power consumption of the wireless communication system 100 can be reduced by the operation described in above 1. to 3.

Next, we will describe detail of the radio apparatuses 1A, 1B, 1C. In the description, we pick up one of the radio apparatuses 1A to explain. Other radio apparatuses 1B, 1C are same as the radio apparatus 1A.

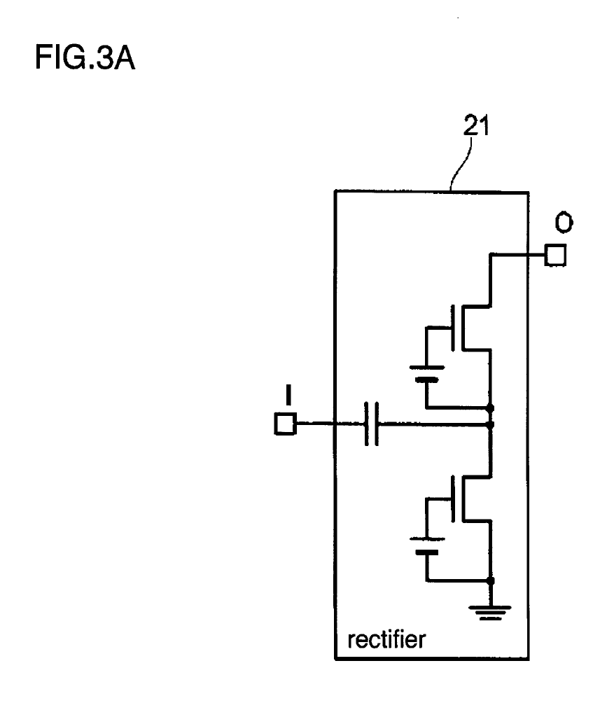

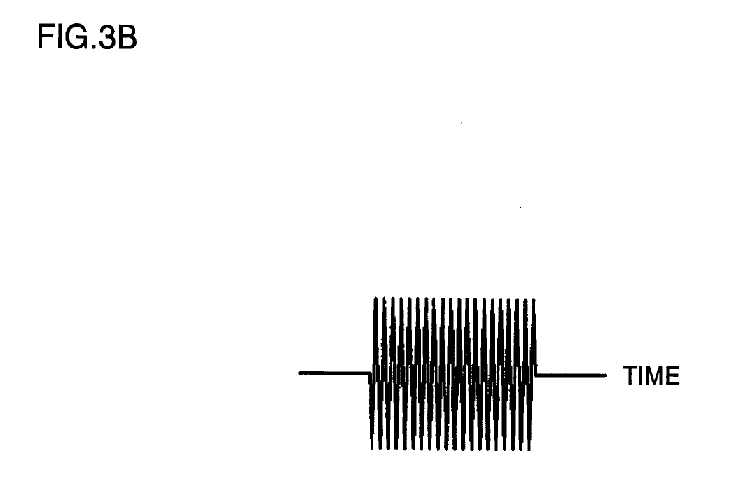

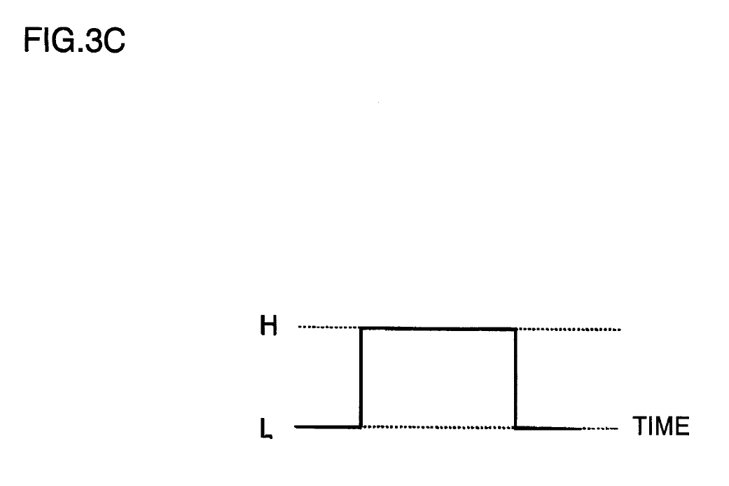

The antennas 50, 60 receives signals transmitted from the other radio apparatuses 1B, 1C as receiving signals. As shown in FIG. 3A, the receiving signal from the antenna 50 is input into an input terminal “I” of the rectifier 21. The rectifier 21 rectifies the receiving signal and outputs it form an output terminal “O” to the power watching unit 22. FIG. 3B shows the receiving signal inputted into the input terminal “I” of the rectifier 21. FIG. 3C shows the receiving signal outputted from the output terminal “O” of the rectifier 21.

The power watching unit 22 compares power level of the receiving signal from the rectifier 21 with a threshold. The threshold may be preliminarily memorized in the power watching unit 22. If the power level is larger than the threshold, the power watching unit 22 keeps being watching the power level of the receiving signal from the rectifier 21. If the power level of the receiving signal becomes smaller than the threshold, the power watching unit 22 outputs a signal notification indicating arrival of the receiving signal to the mode checking unit 23. The signal notification may be the receiving signal.

When the mode checking unit 23 receives the signal notification from the power watching unit 22, the mode checking unit 23 checks whether or not the transmitting and receiving unit 40 is in the sleep mode. If the transmitting and receiving unit 40 is in the sleep mode, the mode checking unit 23 outputs the signal notification to the wake-up determining unit 30.

The wake-up determining unit 30 includes a timer 30a and a memory 30b. The timer 30a counts time. The memory 30b memorizes the time interval T1 (SIFS). The wake-up determining unit 30 measures time interval of between inputs of two signal notifications from the mode checking unit 23 by the timer 30a. If the time interval counted by the timer 30a is larger than the time interval T1 (SIFS) memorized in the memory 30b, the wake-up determining unit 30 determines that the receiving signal is the association request signal. If the receiving signal is the association request signal, the wake-up determining unit 30 outputs a wake-up indication to the receiving unit 42.

The receiving unit 42 is normally in the sleep mode. If the receiving unit 42 receives the wake-up indication from the wake-up determining unit 30, the receiving unit 42 quits the sleep mode and transits to the waiting mode.

The RF unit 43 down-converts a frequency of the receiving signal from the antenna 60 to a lower frequency to obtain a baseband signal. Then, the RF unit 43 outputs the baseband signal to the receiving unit 42. If the receiving unit 42 guesses that the receiving signal may be the association request signal, the receiving unit 42 outputs the wake-up indication to the transmitting unit 41. The transmitting unit 41 is normally in the sleep mode. If the transmitting unit 41 receives the wake-up indication from the receiving unit 42, the transmitting unit 41 quits the sleep mode and is activated.

The transmitting unit 41 generates the association response signal and outputs it to the RF unit 43. The RF unit 43 converts a frequency of the association response signal to a higher frequency for transmission. Then, the RF unit 43 outputs the association response signal to the antenna 60.

The transmitting unit 41 and the receiving unit 42 may be connected to an upper layer (not shown). Moreover, the antennas 50, 60 may be formed in one antenna. The mode checking unit 23 may be included in the wake-up determining unit 30.

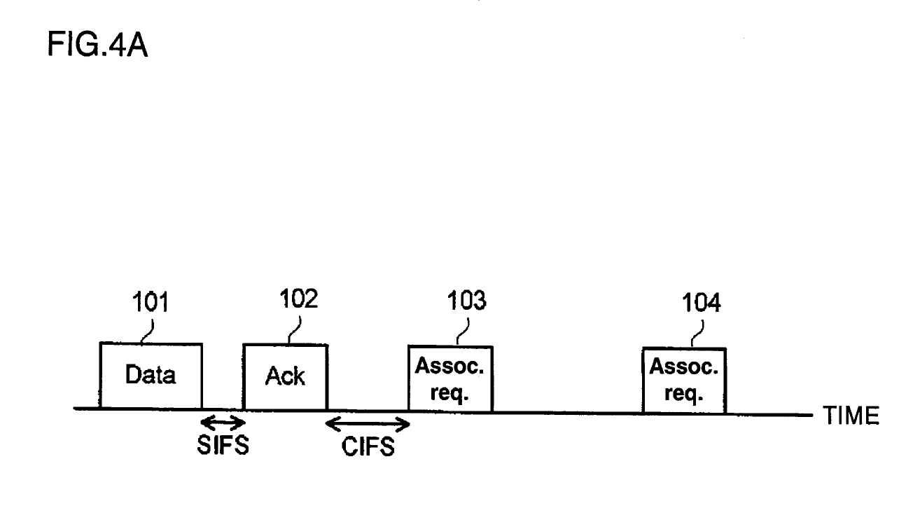

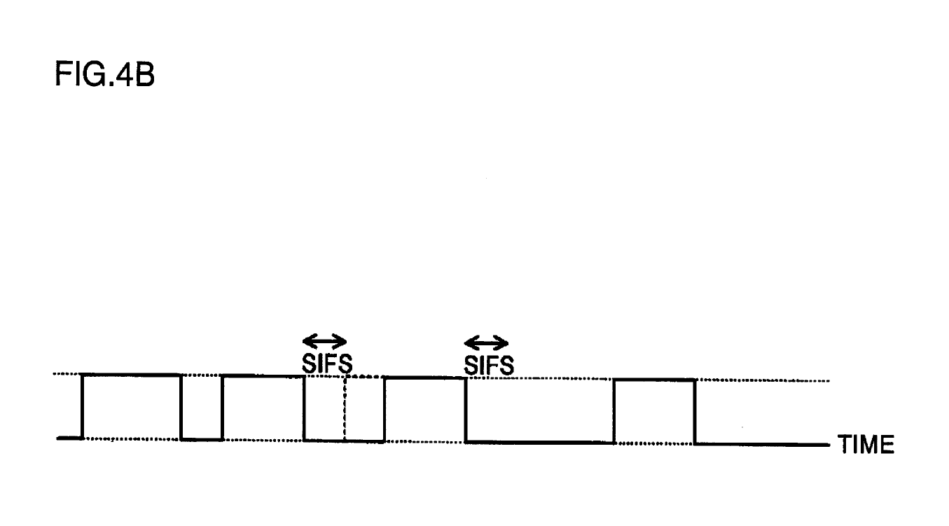

Next, we will explain time intervals between transmissions in the wireless communication system 100. We consider an example that the radio apparatus 1A first communicates with the radio apparatus 1C and then the radio apparatus 1A tries to communicate with the radio apparatus 1B. FIG. 4A shows signals transmitted in a frequency band following time. FIG. 4B shows signals inputted into the power watching unit 22 from the rectifier 21 in the radio apparatus 1B.

In FIG. 4A, the radio apparatus 1C transmits a data signal 101 to the radio apparatus 1A. When the radio apparatus 1A receives the data signal 101, the radio apparatus 1A transmits an acknowledge signal 102 to the radio apparatus 1C after the time interval T1 has passed.

Next, the radio apparatus 1A transmits an association request signal 103 to the radio apparatus 1B in order to request establishing a connection with the radio apparatus 1B. The radio apparatus 1A transmits the association request signal 103 after a time interval T2 (second time interval) has passed. The time interval T2 may be a CIFS (Control Inter Frame Space).

In the first embodiment, the radio apparatuses 1A, 1B, 1C perform the random backoff due to the contention window (CW) before transmitting the association request signal 103 in order to avoid collisions of signals. However, the radio apparatuses 1A, 1B, 1C may not perform the random backoff. In this case, the time interval T2 may have a fixed duration.

The radio apparatus 1A repeatedly transmits the association request signal 104 with the time interval T2 to the radio apparatus 1B until the radio apparatus 1A receives the association response signal from the radio apparatus 1B. The radio apparatus 1B receives the signals at the antenna 50 as shown in FIG. 4B.

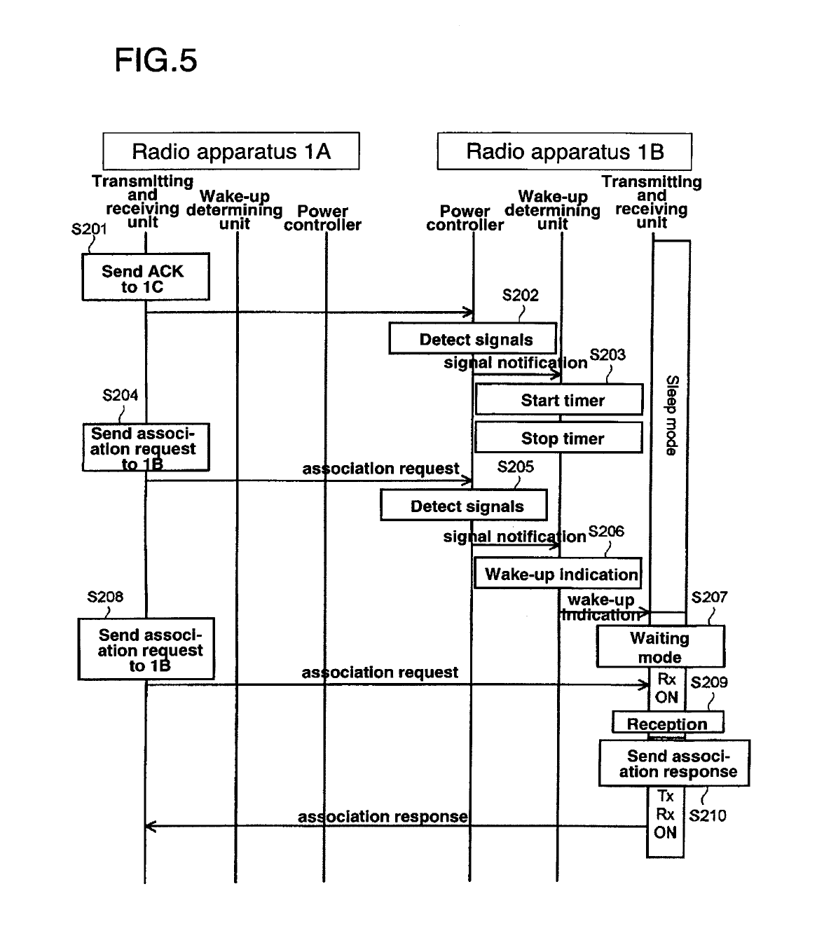

Hereinafter, we will describe operation of the wireless communication system 100. In FIG. 5, a signal sequence starts from that the radio apparatus 1A transmits the acknowledgement signal 102 (or the association request signal 103).

As shown in FIG. 5, the radio apparatus 1A transmits the acknowledgement signal 102 to the radio apparatus 1C (in the step S201). The radio apparatus 1B receives the acknowledgement signal 102 at the antenna 50 and inputs it into the rectifier 21. The rectifier 21 rectifies the acknowledgement signal 102 and outputs it to the power watching unit 22.

The power watching unit 22 compares power level of the acknowledgement signal 102 from the rectifier 21 with the threshold memorized in the power watching unit 22. In this case, since the power level is larger than the threshold, the power watching unit 22 keeps being watching the power level of the acknowledgement signal 102. If the power level of the acknowledgement signal 102 becomes smaller than the threshold, the power watching unit 22 outputs the signal notification to the mode checking unit 23 (in the step S202).

When the mode checking unit 23 receives the signal notification from the power watching unit 22, the mode checking unit 23 checks whether the transmitting and receiving unit 40 is in the sleep mode or not. In this example, since the transmitting and receiving unit 40 is in the sleep mode, the mode checking unit 23 outputs the signal notification to the wake-up determining unit 30.

When the wake-up determining unit 30 receives the signal notification from the mode checking unit 23, the wake-up determining unit 30 starts to count time by the timer 30a (in the step 203).

After the radio apparatus 1A transmits the acknowledgement signal 102 to the radio apparatus 10, the radio apparatus 1A transmits the association request signal 103 to the radio apparatus 18 (in the step S204) after the time interval T2 (CIFS) has passed. The radio apparatus 18 receives the association request signal 103 at the antenna 50. Then, the power controller 20 outputs the signal notification to the wake-up determining unit 30 (in the step S205).

When the wake-up determining unit 30 receives the signal notification from the power controller 20, the wake-up determining unit 30 compares the time counted by the timer 30a with the time interval T1 (SIFS) memorized in the memory 30b. In the first embodiment, the time interval T2 (CIFS) is larger than the time interval T1 (SIFS). Since the time interval T2 (CIFS) is used to transmit the association request signal 103, the wake-up determining unit 30 determines the time counted by the timer 30a is larger than the time interval T1 (SIFS). In the first embodiment, although the time interval T1 is SIFS, the time interval T1 may be longer than SIFS. In the case of the time interval T1 being longer than SIFS, the wake-up determining unit 30 compares the time counted by the timer 30a with the time interval T1 being longer than SIFS instead of SIFS in above description.

The wake-up determining unit 30 determines that the receiving signal may be the association request signal based on the time interval T2. Then, the wake-up determining unit 30 outputs the wake-up indication to the receiving unit 42 (in the step S206). When the receiving unit 42 receives the wake-up indication from the wake-up determining unit 30, the receiving unit 42 quits the sleep mode and transits to the waiting mode (in the step S207).

Since the radio apparatus 1A has not received the association response signal from the radio apparatus 1B, the radio apparatus 1A retransmits the association request signal 104 to the radio apparatus 1B (in the step S208). On the other hand, the receiving unit 42 of the radio apparatus 1B is in the waiting mode. Therefore, the receiving unit 42 analyzes the association request signal 104 received at the antenna 60 to check whether the receiving signal is the association request signal 104 having a destination of the radio apparatus 1B (in the step S209).

After the receiving unit 42 recognizes that the receiving signal is the association request signal 104 having a destination of the radio apparatus 1B, the receiving unit 42 outputs the wake-up indication to the transmitting unit 41. The transmitting unit 41 quits the sleep mode and is activated. Then, the transmitting unit 41 generates the association response signal and transmits it to the radio apparatus 1A through the antenna 60 (in the step S210). After that, the radio apparatuses 1A, 1B exchanges authentication signal and data signals with the time interval T1 (SIFS).

If the wake-up determining unit 30 receives the wake-up indication from the mode checking unit 23 within the time interval T1 (SIFS) after the timer 30a starts to count time in the step S203, the wake-up determining unit 30 resets the timer 30a to zero because it determines that the receiving signal is not the association request signal. Moreover, if the destination of the association request signal is not the radio apparatuses 1B in the step S209, the receiving unit 42 returns back to the sleep mode again.

In the above description, the receiving unit 42 is activated by receiving the wake-up indication from the wake-up determining unit 30. Moreover, the transmitting unit 41 is activated by receiving the wake-up indication from the receiving unit 42. However, both the receiving unit 42 and the transmitting unit 41 may be activated by receiving the wake-up indication from the wake-up determining unit 30.

According to the first embodiment, the wireless communication system 100 uses the two different time intervals T1 (SIFS) and T2 (CIFS). The time interval T1 (SIFS) is used to transmit the acknowledgement signal and the time interval T2 (CIFS) is used to transmit the association request signal. Moreover, the radio apparatus detects the association request signal based on the time interval T2. When it is confirmed that the receiving signal is the association request signal by analyzing the receiving signal, the transmitting and receiving unit 40 quits the sleep mode and transits to the waiting mode.

Therefore, only when the radio apparatus actually receives the association request signal, the transmitting and receiving unit 40 of the radio apparatus can be activated. As a result, the radio apparatus achieves low power consumption.

In the first embodiment, the wake-up determining unit 30 activates the receiving unit 42, when the time counted by the timer 30a until the wake-up indication is received is larger than the time interval T1 (SIFS). However, when the time counted by the timer 30a exceeds the time interval T1, the wake-up determining unit 30 may activate the receiving unit 42 because the receiving signal may be the association request signal.

### Description of the Second Embodiment

In the first embodiment, each radio apparatus in the wireless communication system 100 uses only one time interval T2 for transmitting the association request signal. Therefore, if the wireless communication system 100 has plural of channels to communicate, it may be difficult for the radio apparatus to determine which channel is used to transmit the association request signal.

In the second embodiment, each radio apparatus in a wireless communication system 200 uses plural of time intervals for transmitting the association request signal. Each time interval is corresponding to each of the channels. Therefore, the radio apparatus can determine which channel is used to transmit the association request signal by measuring duration of the time interval.

Hereinafter, we will explain the wireless communication system 200 and the radio apparatus in the second embodiment. The wireless communication system 200 includes radio apparatuses 2A, 2B, 2C. Each of the radio apparatuses 2A, 2B, 2C acts as both a transmitter and a receiver.

In the second embodiment, the wireless communication system 200 has three channels A, B, C. The number of the channels is not limited to three.

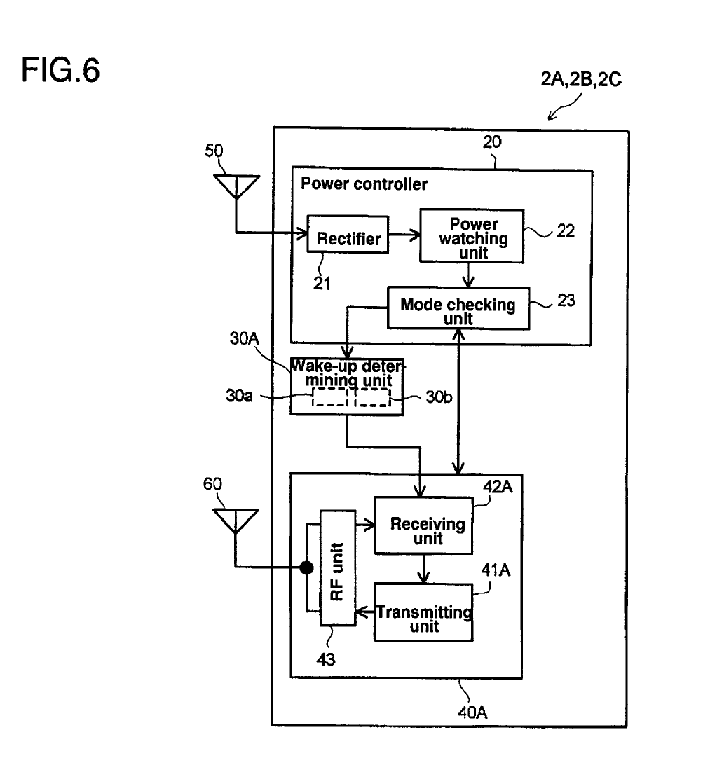

As shown in FIG. 6, each of the radio apparatuses 2A, 2B, 2C includes a power controller 20, a wake-up determining unit 30A, a transmitting and receiving unit 40A, an antenna 50, and an antenna 60. The power controller 20 further includes a rectifier 21, a power watching unit 22, and a mode checking unit 23. The transmitting and receiving unit 40A further includes a transmitting unit 41A, a receiving unit 42A, and an RF unit 43. Since the power controller 20, the antenna 50, and the antenna 60 are same as them of the first embodiment, these descriptions are skipped. Therefore, the wake-up determining unit 30A and the transmitting and receiving unit 40A are mainly explained below.

The wake-up determining unit 30A includes a timer 30a and a memory 30b. The timer 30a counts time. The memory 30b memorizes the time interval T1 (SIFS) for transmitting the acknowledgement signal and time intervals TA, TB, TC which are corresponding to the three channels A, B, C, respectively. The wake-up determining unit 30A counts time interval of between inputs of the two signal notifications from the mode checking unit 23 by the timer 30a. The wake-up determining unit 30A determines whether or not the receiving signal from the antenna 50 is the association request signal and which channel is used to transmit the association request signal (hereinafter, referred to as “channel information”) by comparing the time counted by the timer 30a with each of the time intervals TA, TB, TC memorized in the memory 30b.

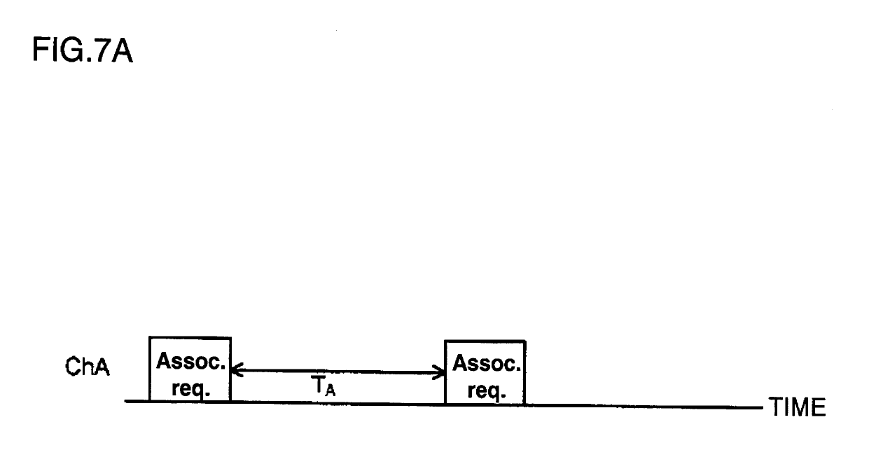

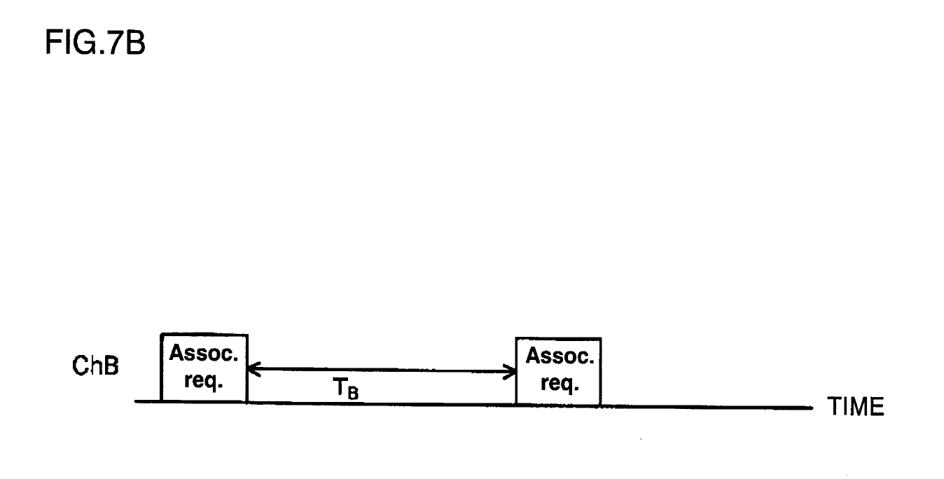

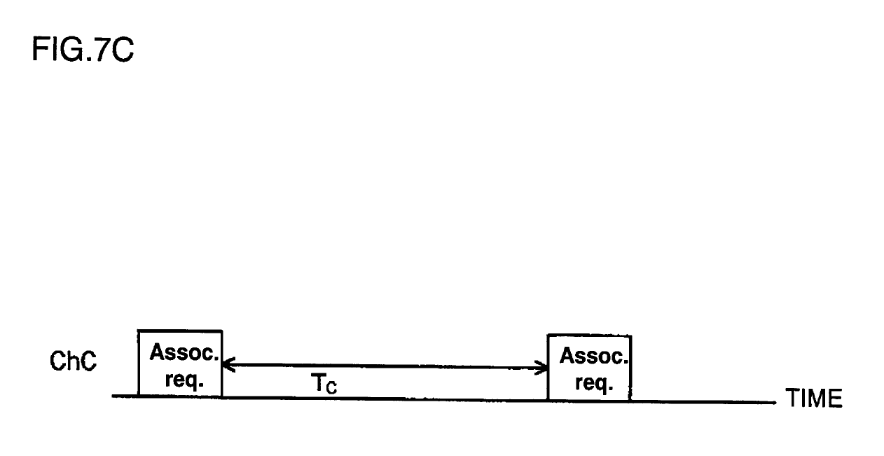

FIGS. 7A, 7B, 7C show the time intervals TA, TB, TC for the channels A, B, C, respectively. In the second embodiment, the time interval TA is the shortest and the time interval TC is the longest in the three time intervals TA, TB, TC.

If the time interval of between inputs of two signal notifications from the mode checking unit 23 is larger than the time interval T1 (SIFS) and smaller than the time interval TA, the wake-up determining unit 30A determines that the receiving signal from the antenna 50 is the association request signal using the channel A.

If the time interval of between inputs of two signal notifications from the mode checking unit 23 is larger than the time interval TA and smaller than the time interval TB, the wake-up determining unit 30A determines that the receiving signal from the antenna 50 is the association request signal using the channel B.

If the time interval of between inputs of two signal notifications from the mode checking unit 23 is larger than the time interval TB and smaller than the time interval TC, the wake-up determining unit 30A determines that the receiving signal from the antenna 50 is the association request signal using the channel C.

After the wake-up determining unit 30A determines the channel information as described above, the wake-up determining unit 30A outputs the wake-up indication with the channel information to the receiving unit 42A.

The receiving unit 42A is normally in the sleep mode. If the receiving unit 42A receives the wake-up indication with the channel information, the receiving unit 42A quits the sleep mode and transits to the waiting mode. In the waiting mode, the receiving unit 42A waits to receive signals from the antenna 60 using the channel indicated by the channel information.

If the receiving signal from the antenna 60 is the association request signal, the receiving unit 42A outputs the wake-up indication with the channel information to the transmitting unit 41A.

The transmitting unit 41A is normally in the sleep mode. If the transmitting unit 41A receives the wake-up indication with the channel information from the receiving unit 42, the transmitting unit 41A quits the sleep mode and is activated. Then, the transmitting unit 41A prepares to transmit using the channel indicated by the channel information.

The transmitting unit 41A generates the association response signal and outputs it to the RF unit 43. The transmitting unit 41A and the receiving unit 42A may be connected to an upper layer (not shown).

The time interval TA, TB, TC may be fixed duration. Or, the time interval TA, TB, TC may be determined using the Contention Window (CW) of the random backoff. The Contention Window (CW) has a maximum number CWmax and a minimum number CWmin. The random backoff is performed using the Contention Window (CW) of which value is randomly chosen between the maximum number CWmax and the minimum number CWmin.

For example, the Contention Windows for channels are set as below.

Channel A: (CWmax, CWmin) is equal to (0, 5).
Channel B: (CWmax, CWmin) is equal to (6, 10).
Channel C: (CWmax, CWmin) is equal to (11, 15).

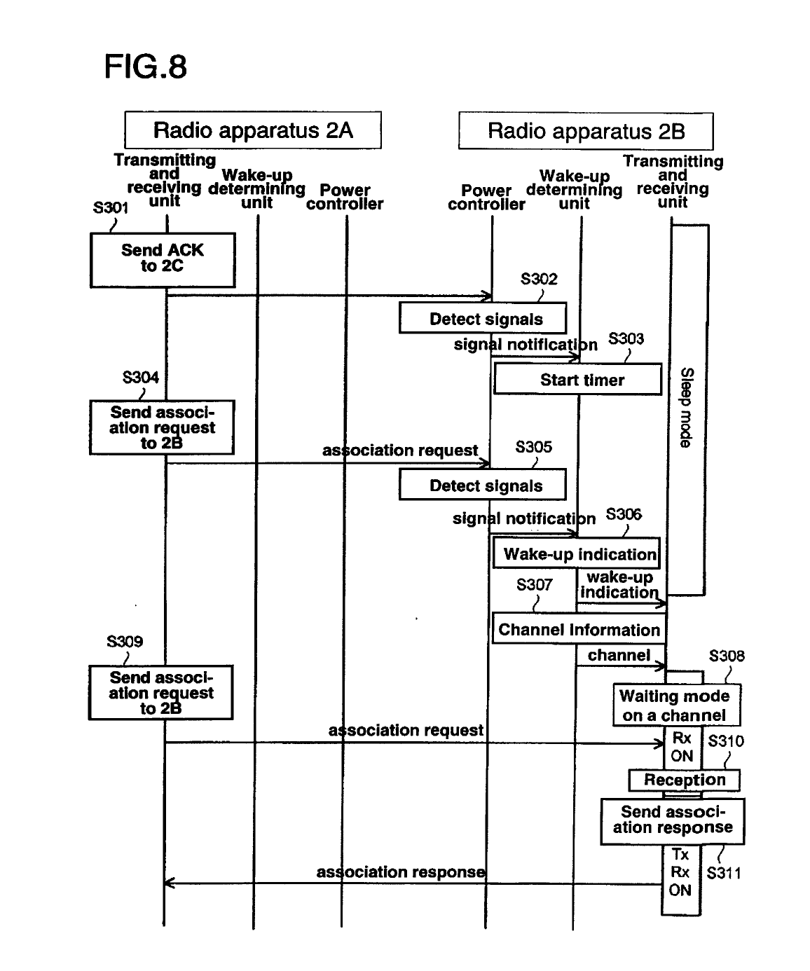

Hereinafter, we will describe operation of the wireless communication system 200 with reference to FIG. 8. We consider an example that the radio apparatus 2A first communicates with the radio apparatus 2C and then the radio apparatus 2A tries to communicate with the radio apparatus 2B as same as the first embodiment shown in FIG. 5.

As shown in FIG. 8, the radio apparatus 2A transmits the acknowledgement signal to the radio apparatus 2C (in the step S301). The radio apparatus 2B receives the acknowledgement signal at the antenna 50 and inputs it into the rectifier 21. The rectifier 21 rectifies the acknowledgement signal and outputs it to the power watching unit 22.

The power watching unit 22 compares power level of the acknowledgement signal from the rectifier 21 with the threshold memorized in the power watching unit 22. In this case, since the power level is larger than the threshold, the power watching unit 22 keeps being watching the power level of the acknowledgement signal. If the power level of the acknowledgement signal becomes smaller than the threshold, the power watching unit 22 outputs the signal notification to the mode checking unit 23 (in the step S302).

When the mode checking unit 23 receives the signal notification from the power watching unit 22, the mode checking unit 23 checks whether the transmitting and receiving unit 40A is in the sleep mode or not. In this example, since the transmitting and receiving unit 40A is in the sleep mode, the mode checking unit 23 outputs the signal notification to the wake-up determining unit 30A.

When the wake-up determining unit 30A receives the signal notification from the mode checking unit 23, the wake-up determining unit 30A starts to count time by the timer 30a (in the step 303).

After the radio apparatus 2A transmits the acknowledgement signal to the radio apparatus 2C, the radio apparatus 2A transmits the association request signal to the radio apparatus 2B (in the step S304) after one of the time intervals TA, TB, TC corresponding to the channel information has passed. The radio apparatus 2B receives the association request signal at the antenna 50. Then, the power controller 20 outputs the signal notification to the wake-up determining unit 30A (in the step S305).

When the wake-up determining unit 30A receives the signal notification from the power controller 20, the timer 30a stops counting time. Then, the wake-up determining unit 30A compares the time counted by the timer 30a with each of the time intervals TA, TB, TC memorized in the memory 30b. The wake-up determining unit 30A determines the channel information is which of the channels A, B, C based on the time counted by the timer 30a.

The wake-up determining unit 30A outputs the wake-up indication with the channel information to the receiving unit 42A (in the steps S306, S307).

When the receiving unit 42A receives the wake-up indication with the channel information from the wake-up determining unit 30A, a part of the receiving unit 42 corresponding to the channel information quits the sleep mode and transits to the waiting mode (in the step S308).

Since the radio apparatus 2A has not received the association response signal from the radio apparatus 2B, the radio apparatus 2A retransmits the association request signal to the radio apparatus 2B (in the step S309). On the other hand, the receiving unit 42A of the radio apparatus 2B is in the waiting mode. Therefore, the receiving unit 42A receives the association request signal at the antenna 60 as the receiving signal and checks whether the receiving signal is the association request signal having the destination of the radio apparatus 2B (in the step S310).

After the receiving unit 42A recognizes that the receiving signal from the antenna 60 is the association request signal having the destination of the radio apparatus 2B, the receiving unit 42A outputs the wake-up indication with the channel information to the transmitting unit 41A. If the transmitting unit 41A receives the wake-up indication with the channel information, part of the transmitting unit 41A corresponding to the channel information is activated. Then, the transmitting unit 41A generates the association response signal and transmits it to the radio apparatus 2A through the antenna 60 (in the step S311). After that, the radio apparatuses 2A, 2B exchanges authentication signal and data signals.

If the wake-up determining unit 30A receives the wake-up indication from the mode checking unit 23 within the time interval T1 (SIFS) after the timer 30a starts to count the time in the step S303, the wake-up determining unit 30A resets the timer 30a to zero because it determines that the receiving signal is not the association request signal. Moreover, if the receiving signal from the antenna 60 is not the association request signal having the destination of the radio apparatus 2B in the step S310, the receiving unit 42A returns back to the sleep mode again.

In the above description, the receiving unit 42A is activated by receiving the wake-up indication from the wake-up determining unit 30A. Moreover, the transmitting unit 41A is activated by receiving the wake-up indication from the receiving unit 42A. However, both the receiving unit 42A and the transmitting unit 41A may be activated by receiving the wake-up indication from the wake-up determining unit 30A.

According to the second embodiment, the wireless communication system 200 uses the different time intervals according to the channels used to transmit the association request signal. Moreover, the radio apparatus determines which channel is used to transmit the association request signal based on the duration of the time interval.

Therefore, the transmitting and receiving unit 40A does not need to search channels to transmit signals. As a result, the radio apparatus achieves low power consumption. Other advantages are same as the first embodiment.

### Description of the Third Embodiment

In the wireless communication system 100 of the first embodiment, the power controller 20 in the radio apparatus may incorrectly determine that a receiving noise is the association request signal. In this case, the transmitting and receiving unit 40 may be activated and consume power uselessly.

In a wireless communication system 300 of the third embodiment, the radio apparatus transmits the association request signal using different transmission power for each transmission in order to avoid activating the transmitting and receiving unit 40 incorrectly. The other radio apparatus receives the association request signal with varying reception sensitivity.

Specifically, after receiving the association request signal with high reception sensitivity, the radio apparatus decreases the reception sensitivity for reception of next association request signal. On the other hand, the radio apparatus increases the reception sensitivity after receiving the association request signal with low reception sensitivity.

After the radio apparatus receives two association request signals using high and low reception sensitivities respectively, the transmitting and receiving unit 40 is activated. Accordingly, the radio apparatus can reduce probability that the transmitting and receiving unit 40 is incorrectly activated.

Hereinafter, we will explain the wireless communication system 300 and the radio apparatus in the third embodiment. The wireless communication system 300 includes radio apparatuses 3A, 3B, 3C. Each of the radio apparatuses 3A, 3B, 3C acts as both a transmitter and a receiver.

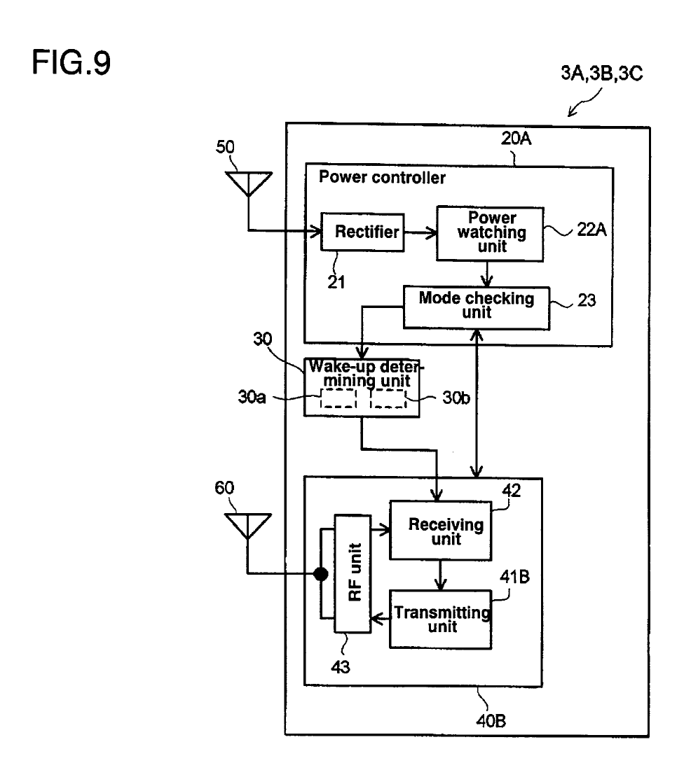

As shown in FIG. 9, each of the radio apparatuses 3A, 3B, 3C includes a power controller 20A, a wake-up determining unit 30, a transmitting and receiving unit 40B, an antenna 50, and an antenna 60. The power controller 20A further includes a rectifier 21, a power watching unit 22A, and a mode checking unit 23. The transmitting and receiving unit 40B further includes a transmitting unit 41B, a receiving unit 42, and an RF unit 43. Since the wake-up determining unit 30, the antenna 50, and the antenna 60 are same as them of the first embodiment, these descriptions are skipped. Therefore, the power controller 20A and the transmitting and receiving unit 40B are mainly explained below.

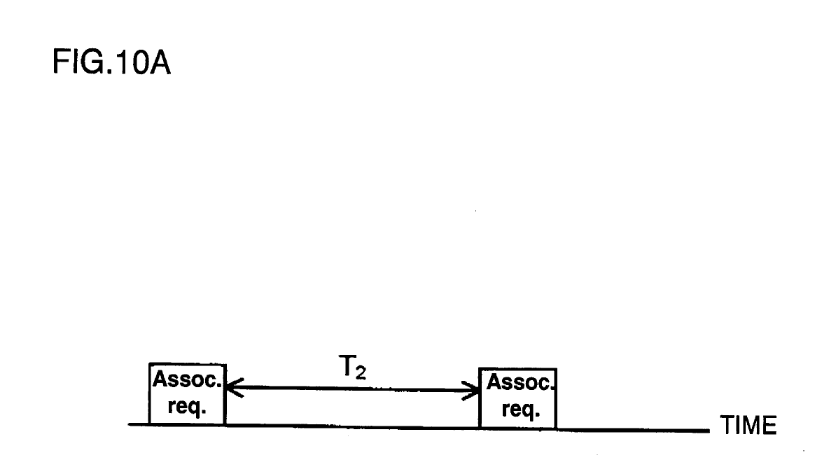

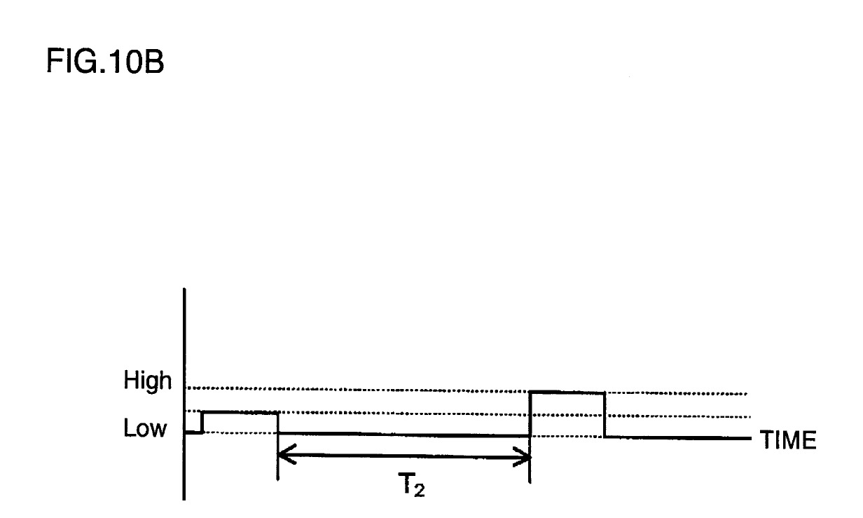

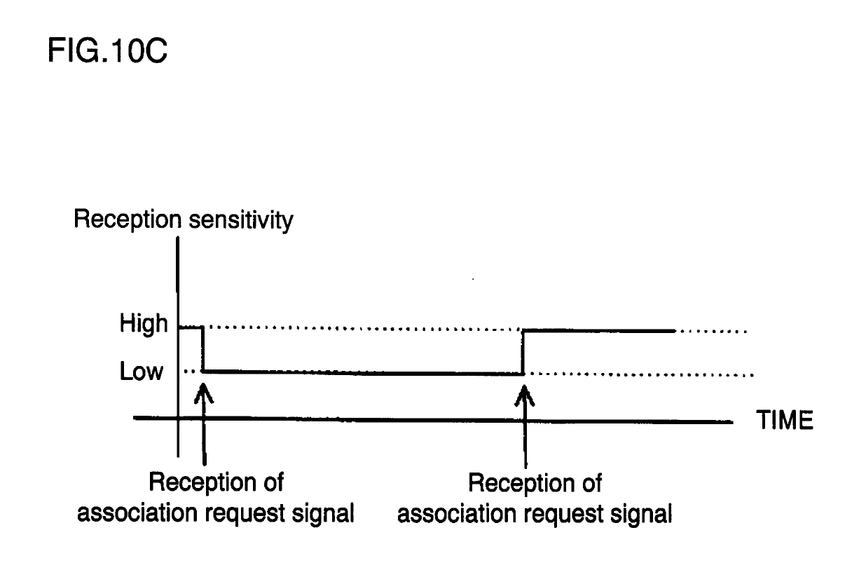

As shown in FIG. 10A, the transmitting unit 41B transmits the association request signals with the time interval T2 (CIFS). As shown in FIG. 10B, these association request signals are transmitted using high power and low power alternately.

As shown in FIG. 10C, the power watching unit 22A varies low and high reception sensitivities alternately for each reception of the association request signal. Specifically, after receiving the association request signal with high reception sensitivity, the power watching unit 22A decreases the reception sensitivity for reception of next association request signal. On the other hand, the power watching unit 22A increases the reception sensitivity after receiving the association request signal with low reception sensitivity.

The power watching unit 22A compares power level of the signal from the rectifier 21 with a threshold given preliminarily as same as the first embodiment. If the power level is larger than the threshold, the power watching unit 22A keeps being watching the power level of the signal from the rectifier 21. If the power level of the signal becomes smaller than the threshold, the power watching unit 22A outputs the signal notification into the mode checking unit 23.

In the third embodiment, the power watching unit 22A has a high threshold (hereinafter, referred to as “first threshold”) and a low threshold (hereinafter, referred to as “second threshold”). The high threshold realizes the low reception sensitivity and the low threshold realizes the high reception sensitivity. The power watching unit 22A varies the reception sensitivity by switching the first and second thresholds for each reception of the association request signal.

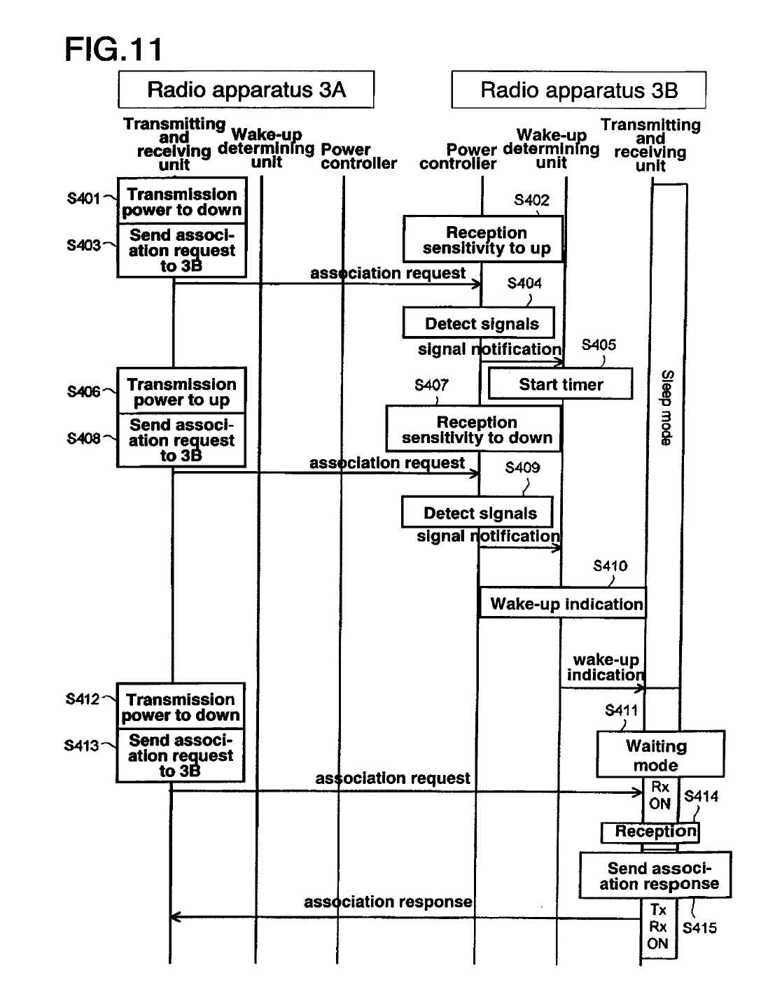

Hereinafter, we will describe operation of the wireless communication system 300 with reference to FIG. 11. We consider an example that the radio apparatus 3A transmits the association request signal to the radio apparatus 3B.

As shown in FIG. 11, the radio apparatus 3A varies the transmission power to be low (in the step S401). On the other hand, the radio apparatus 3B varies the reception sensitivity to be high (in the step S402). Specifically, the power watching unit 22A of the radio apparatus 3B adopts the second threshold. Then, the radio apparatus 3A transmits the association request signal to the radio apparatus 3B (in the step S403).

The radio apparatus 3B receives the association request signal at the antenna 50. The rectifier 21 rectifies the association request signal and outputs it to the power watching unit 22A. The power watching unit 22A compares power level of the association request signal from the rectifier 21 with the second threshold (in the step S404).

In this case, since the power level is larger than the threshold, the power watching unit 22A keeps being watching the power level of the association request signal from the rectifier 21. If the power level of the association request signal becomes smaller than the second threshold, the power watching unit 22A outputs the signal notification to the mode checking unit 23.

When the mode checking unit 23 receives the signal notification from the power watching unit 22A, the mode checking unit 23 checks whether the transmitting and receiving unit 40B is in the sleep mode or not. In this example, since the transmitting and receiving unit 40B is in the sleep mode, the mode checking unit 23 outputs the signal notification to the wake-up determining unit 30.

When the wake-up determining unit 30 receives the signal notification from the mode checking unit 23, the wake-up determining unit 30 starts to count time by the timer 30a (in the step 405).

Next, the radio apparatus 3A varies the transmission power to be high (in the step S406). On the other hand, the radio apparatus 3B varies the reception sensitivity to be low (in the step S407). Specifically, the power watching unit 22A of the radio apparatus 3B adopts the first threshold. Then, the radio apparatus 3A transmits the association request signal to the radio apparatus 3B (in the step S408).

The radio apparatus 3B receives the association request signal at the antenna 50. The rectifier 21 rectifies the association request signal and outputs it to the power watching unit 22A. The power watching unit 22A compares power level of the association request signal from the rectifier 21 with the first threshold (in the step S409).

In this case, since the power level is larger than the threshold, the power watching unit 22A keeps being watching the power level of the association request signal from the rectifier 21. If the power level of the association request signal becomes smaller than the second threshold, the power watching unit 22A outputs the signal notification to the mode checking unit 23.

When the mode checking unit 23 receives the signal notification from the power watching unit 22A, the mode checking unit 23 checks whether the transmitting and receiving unit 40B is in the sleep mode or not. In this example, since the transmitting and receiving unit 40B is in the sleep mode, the mode checking unit 23 outputs the signal notification to the wake-up determining unit 30.

When the wake-up determining unit 30 receives the signal notification from the mode checking unit 23, the wake-up determining unit 30 compares the time counted by the timer 30a with the time interval T1 (SIFS) memorized in the memory 30b. In the third embodiment, the time interval T2 (CIFS) is larger than the time interval T1 (SIFS). Since the time interval T2 (CIFS) is used to transmit the association request signal 103, the wake-up determining unit 30 determines that the time counted by the timer 30a is larger than the time interval T1 (SIFS).

The wake-up determining unit 30 determines that the receiving signal from the antenna 50 may be the association request signal based on the time interval T2. Then, the wake-up determining unit 30 outputs the wake-up indication to the receiving unit 42 (in the step S410). When the receiving unit 42 receives the wake-up indication from the wake-up determining unit 30, the receiving unit 42 quits the sleep mode and transits to the waiting mode (in the step S411).

Since the radio apparatus 3A has not received the association response signal from the radio apparatus 3B, the radio apparatus 3A varies the transmission power to be low (in the step S412). Then, the radio apparatus 3A retransmits the association request signal to the radio apparatus 3B (in the step S413).

On the other hand, the receiving unit 42 of the radio apparatus 3B is in the waiting mode. Therefore, the receiving unit 42 analyzes the association request signal received at the antenna 60 to check whether the receiving signal from the antenna 60 is the association request signal having the destination of the radio apparatus 3B (in the step S414).

After the receiving unit 42 recognizes that the receiving signal from the antenna 60 is the association request signal having the destination of the radio apparatus 3B, the receiving unit 42 outputs the wake-up indication to the transmitting unit 41B. If the transmitting unit 41B receives the wake-up indication, the transmitting unit 41B quits the sleep mode and is activated. Then, the transmitting unit 41B generates the association response signal and transmits it to the radio apparatus 3A through the antenna 60 (in the step S415). After that, the radio apparatuses 3A, 3B exchanges authentication signal and data signals.

If the wake-up determining unit 30 receives the wake-up indication from the mode checking unit 23 within the time interval T1 (SIFS) after the timer 30a starts to count the time in the step S405, the wake-up determining unit 30 resets the timer 30a to zero because it determines that the receiving signal is not the association request signal. Moreover, if the receiving signal is the association request signal having the destination of the radio apparatus 3B in the step S414, the receiving unit 42 returns back to the sleep mode again.

In the above description, the receiving unit 42 is activated by receiving the wake-up indication from the wake-up determining unit 30. Moreover, the transmitting unit 41B is activated by receiving the wake-up indication from the receiving unit 42. However, both the receiving unit 42 and the transmitting unit 41B may be activated by receiving the wake-up indication from the wake-up determining unit 30.

In the third embodiment, the wireless communication system 300 adopts one channel. However, The wireless communication system 300 may adopt plural channels. In the case of plural channels, the wireless communication system 300 may use the different time intervals according to the channel in order to determine which channel is used to transmit the association request signal based on the duration of the time interval as described in the second embodiment.

According to the third embodiment, the radio apparatus in the wireless communication system 300 activates the transmitting and receiving unit 40B, only when the wireless communication system 300 receives the two association request signal using different powers. Therefore, the radio apparatus can more avoid activating the transmitting and receiving unit 40B incorrectly. As a result, the radio apparatus can reduce probability that the transmitting and receiving unit 40B is uselessly activated and achieve the low power consumption. Other advantages are same as the first embodiment.

In the third embodiment, the radio apparatus transmits a first and second association request signals using high and low transmission powers respectively. After transmission of the two association request signals, a third association request signal may be transmitted using same transmission power as same as the second association request.

### Description of Other Embodiment

In the first to third embodiments, the radio apparatus transmits signals using one channel for one transmission. However, the radio apparatus may transmit signals using plural channels for one transmission.

In the case of the plural channels, interference between channels should be considered. When a radio apparatus 3D tries to communicate with a radio apparatus 1D using some channels, two other radio apparatuses (for example, a radio apparatus 2D and a radio apparatus 4D) may be communicating in other channels. Or, one other radio apparatus (for example, the radio apparatus 2D) and the radio apparatus 1D may be communicating in other channels.

If the radio apparatus 3D is located close to the radio apparatus 1D, interference from the other channels are relatively small. In this case, the radio apparatus 1D may preferably set the reception sensitivity to be a middle power of power levels of the receiving signals from the radio apparatuses 3D, 2D. However, in the case that the radio apparatus 1D communicates with the radio apparatus 3D and other radio apparatus (for example, the radio apparatus 2D) simultaneously, the power levels of the receiving signals may be almost same depending on a distance. In this case, the power controller 20A receives signals in all channels.

Accordingly, the power controller 20 may not detect signals transmitted in a channel B because of interference from communication using a channel A which is adjacent to the channel B. For this problem, the radio apparatus may transmit the association request signal using higher transmission power, and set the reception sensitivity to be low. This realizes to receive only the association request signals. Also, the radio apparatus may decrease the reception sensitivity, if the radio apparatus has not received for a certain time.

Moreover, if the association request signals without destination are transmitted (for example, using broadcasting), the transmitting and receiving unit 40 can skip checking whether the receiving signal is the association request signals having the destination of the its self. In this case, the transmitting and receiving unit 40 may generate the association response signal as soon as the transmitting and receiving unit 40 is activated.

While certain embodiments of the inventions have been described, these embodiments have been presented by way of example only, and are not intended to limit the scope of the inventions. Indeed, the novel methods and systems described herein may be embodied in a variety of other forms: furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication system including a transmitter to transmit signals and a receiver to receive the signals at a transmission interval, one of the signals being an association request signal, comprising:
the transmitter including:
a transmitting unit configured to transmit the signals except the association request signal at the transmission interval of a first time interval, and to transmit the association request signal at the transmission interval of a second time interval, the second time interval being different from the first time interval,
and
the receiver including:
an antenna to receive the signals;
a receiving unit configured to perform receiving processing for the signals; and
a wake-up determining unit configured to determine whether or not the signal is the association request signal based on the transmission interval, the wake-up determining unit activating the receiving unit if the signal is the association request signal.

2. The system of claim 1, wherein
the second time interval is longer than the first time interval.

3. The system of claim 1, wherein
the transmitting unit transmits the association request signal on one of plural frequency bands at the second time interval, the second time interval has durations which each being corresponding to each of the frequency bands.

4. The system of claim 1, wherein
the transmitting unit transmits the association request signal and the other signals with different powers, respectively.

5. The system of claim 1, wherein
the wake-up determining unit further includes a memory storing the transmission interval, and
the wake-up determining unit compares an interval of receiving signals at the antenna with the transmission interval stored in the memory to determine whether or not the signal is the association request signal.

6. The wireless communication system of claim 1, wherein
the receiver further includes a mode checking unit configured to check whether or not the receiving unit is activated, and
the mode checking unit outputs the signal to the wake-up determining unit, if the receiving unit is inactivated.

7. The system of claim 1, wherein
the transmitter transmits the association request signal using different transmission power for each transmission, and
the receiver receives the association request signal using different reception sensitivity for each reception.

8. A transmitter for transmitting signals at a transmission interval, one of the signals being an association request signal, comprising:
a transmitting unit configured to transmit the signals except the association request signal at the transmission interval of a first time interval, and to transmit the association request signal at the transmission interval of a second time interval, the second time interval being different from the first time interval.

9. A receiver, comprising:
an antenna for receiving signals transmitted at a transmission interval;
a receiving unit configured to perform receiving processing for the signals; and
a wake-up determining unit configured to determine whether or not the signal is an association request signal based on the transmission interval, the wake-up determining unit activating the receiving unit if the signal is the association request signal.
